(19) United States
(12) Patent Application Publication
(10) Pub. No.: US 2012/0218770 A1
(43) Pub. Date: Aug. 30, 2012

(54) Easily Maintainable Lamp Connection Device

(75) Inventor: Youneng Mao, Dongguan (CN)

(73) Assignees: WAC LIGHTING CO., Garden City, NY (US); DONGGUAN AMC LIGHTING CO., LTD., Dongguan, Guangdong (CN)

(21) Appl. No.: 13/395,644

(22) PCT Filed: Feb. 24, 2011
(86) PCT No.: PCT/CN11/71218

§ 371 Date: Mar. 12, 2012

(51) Int. Cl. F21V 21/14

(52) U.S. Cl. 362/418

(57) ABSTRACT

The present invention relates to an easily-maintainable lamp connection device. The device comprises a lamp body, a front head arranged at the opening end of the lamp body, and a moveable link rod provided between the lamp body and the front head, which is able to slide freely; a stationary ring positioned firmly at the opening end of the lamp body with having a gap between said stationary ring and the inside wall of the lamp body; the rod body of moveable link rod is arranged with going through said gap, after assembling, the upper end of the moveable link rod located inside of lamp body has a stopper whose size is bigger than that of said gap, and the lower end of moveable link rod located inside of front head is hinge jointed with the hinge mechanism inside of the front head.

### FIELD OF THE INVENTION

The present invention relates to a lamp connection device structure, especially to an easily-maintainable lamp connection device.

### BACKGROUND OF THE INVENTION

It is currently needs to disassemble a front head prior to maintain a domestic lamp device structure in general, in this regard, the front head is separated from the lamp body without any connection, and once the lamp structure needs to be maintained, the front head has to be disassembled and placed well before the operations of maintenance inside of the lamp body, then the front head is assembled back to the lamp body after completing the operations, to assemble or maintain the lamp device, in this way, which is in special environments for example, such as high altitude, is of disadvantages of inconvenience and/or insecurity.

### SUMMARY OF THE INVENTION

An object of the present invention is to provide an easily-maintainable lamp connection device which can still connect a front head to a lamp body together after disassembling the front head in order to eliminate the defects described above.

The object of the present invention may be achieved by the structure described below: an easily-maintainable lamp connection device comprising a lamp body , a front head arranged at the opening end of the lamp body, and a moveable link rod provided between the lamp body and the front head, which is able to slide freely; a stationary ring positioned firmly at the opening end of the lamp body with having a gap between said stationary ring and the inside wall of the lamp body; the rod body of moveable link rod is arranged with going through said gap, after assembling, the upper end of the moveable link rod located inside of lamp body has a stopper whose size is bigger than that of said gap, and the lower end of moveable link rod located inside of front head is hinge jointed with the hinge mechanism inside of the front head.

The front head is lockable arranged at the opening end of said lamp body by using a slot locking structure.

The stationary ring is fixed firmly on a plurality of studs formed inside of said lamp body by using screws.

The hinge mechanism includes an axle and a fixed plate fixed firmly at the inside wall of the front head by using screws, the connecting end of the fixed plate wraps around the axle and forms hinge structure; said lower end of moveable link rod wraps around the axle and forms hinge structure.

Said axle has its both ends of fixed at the inside of assembling recess located on the wall of the front head.

The lamp connection device makes it possible with the structure described herein to keep the connection between the front head and the lamp body by using the moveable link rod to held them together while the bulb needs to be changed and/or the device needs to be maintained and the front head is disassembled, which may make sure security and convenience for operations, especially for one hand operation in special environments for example, such as high altitude etc.

### BRIEF DESCRIPTION OF THE DRAWINGS

FIG. 1 is a cross-sectional, schematic view of the lamp connection device according to the present invention;

FIG. 2 is a partial, cross-sectional view of the connection device according to the present invention;

FIG. 3 is an exploded, perspective view of the lamp connection device according to the present invention;

FIG. 4 is a perspective view of the lamp connection device in using state according to the present invention.

### DETAILED DESCRIPTION OF THE INVENTION

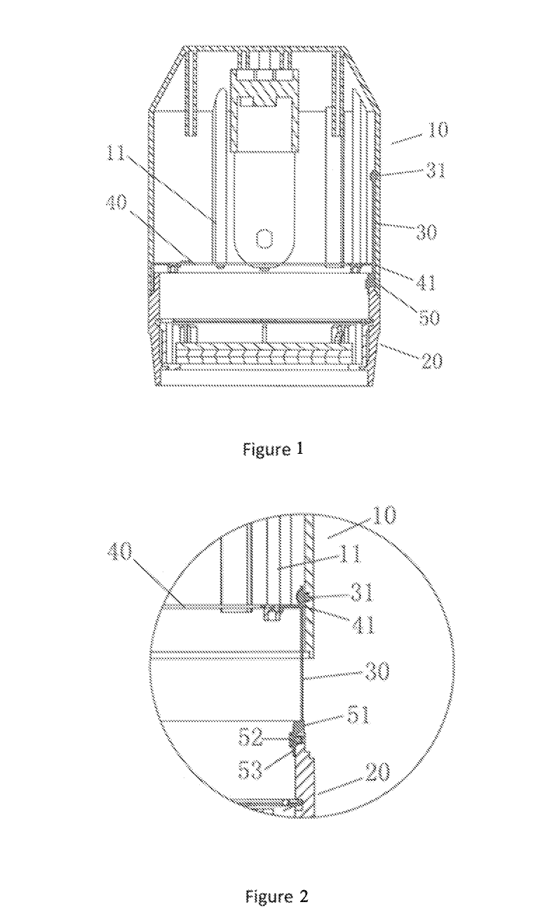

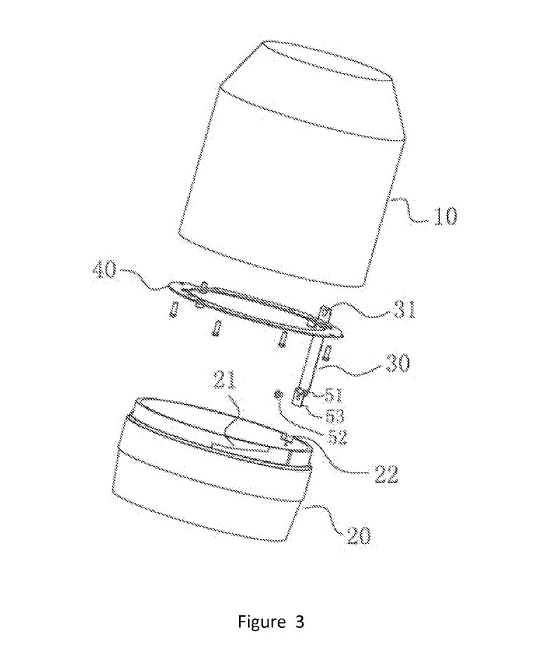

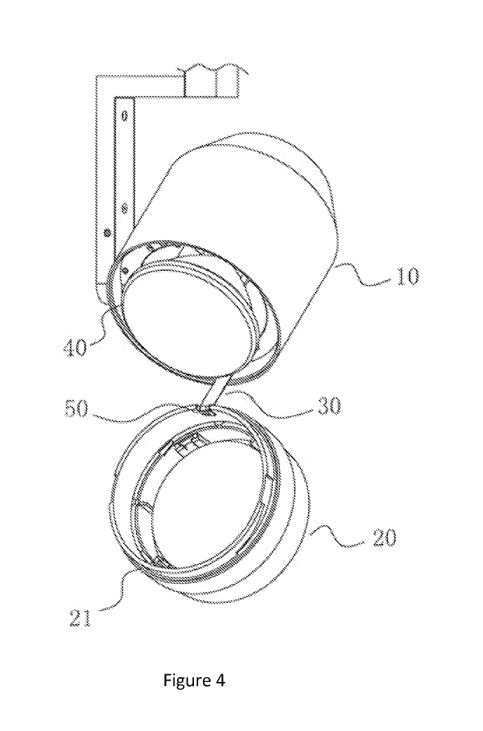

As shown in FIGS. 1-4, the present invention provides an easily-maintainable lamp connection device comprising a lamp body 10, a front head 20 arranged at the opening end of the lamp body 10, and a moveable link rod 30 provided between the lamp body 10 and the front head 20, which is able to slide freely; a stationary ring 40 positioned firmly at the opening end of the lamp body 10 with having a gap 41 between said stationary ring 40 and the inside wall of the lamp body 10; the rod body of moveable link rod 30 is arranged with going through said gap 41, after assembling, the upper end of the moveable link rod 30 located inside of lamp body has a stopper 31 whose size is bigger than that of said gap 41, and the lower end of moveable link rod 30 located inside of front head is hinge jointed with the hinge mechanism 50 inside of the front head 20.

Said front head 20 is lockable arranged at the opening end of said lamp body 10 by using a slot locking structure 21.

Said stationary ring 40 is fixed firmly on a plurality of studs 11 formed inside of said lamp body 10 by using screws 52.

Said hinge mechanism 50 includes an axle 51 and a fixed plate 53 fixed firmly at the inside wall of the front head 20 by using screws 52, the connecting end of the fixed plate 53 wraps around the axle 51 and forms hinge structure; said lower end of moveable link rod 30 wraps around the axle 51 and forms hinge structure.

Said axle 51 has its both ends fixed at the inside of assembling recess 22 located on the wall of the front head 20.

Once the lamp device needs maintenance and/or changing bulb, disassembling the front head 20 and pulling out for a distance away from the lamp body may drive the moveable link rod 30 to slide, but which can not slide off because of being blocked by the stationary ring 40 that the stopper 31 of the moveable link rod 30 is stopped in the gap 41 between the stationary ring 40 and the lamp body 10, in this way, the front head 20 may be separated from the lamp body 10 without losing connection which is helpful for the operations of maintenance conveniently regardless of worrying about the front head 20 falling off, which is suitable for the operations in special environments for example, such as high altitude; the maintenance is completed by pushing the front head 20 back into the lamp body 10 with the moveable link rod 30 being put back the inside of the lamp body 10 and locking the front head after the operations.

It will be appreciated that what described above are only for the preferable example embodiments according to the present invention, thus, it is intended that the present invention covers the modifications and variations of this invention provided they come within the scope of the appended claims and their equivalents.

1. An easily-maintainable lamp connection device comprises a lamp body, a front head arranged at the opening end of the lamp body, and a moveable link rod provided between the lamp body and the front head, which is able to slide freely; a stationary ring positioned firmly at the opening end of the lamp body with having a gap between said stationary ring and the inside wall of the lamp body; the rod body of moveable link rod is arranged with going through said gap, after assembling, the upper end of the moveable link rod located inside of lamp body has a stopper whose size is bigger than that of said gap, and the lower end of moveable link rod located inside of front head is hinge jointed with the hinge mechanism inside of the front head.

2. An easily-maintainable lamp connection device of claim 1, characterized in that said front head is lockable arranged at the opening end of said lamp body by using a slot locking structure.

3. An easily-maintainable lamp connection device of claim 1, characterized in that said stationary ring is fixed firmly on a plurality of studs formed inside of said lamp body by using screws.

4. An easily-maintainable lamp connection device of claim 1, characterized in that said hinge mechanism includes an axle and a fixed plate fixed firmly at the inside wall of the front head by using screws, the connecting end of the fixed plate wraps around the axle and forms hinge structure; said lower end of moveable link rod wraps around the axle and forms hinge structure.

5. An easily-maintainable lamp connection device of claim 4, characterized in that the both ends of said axle are fixed at the inside of assembling recess located on the wall of the front head.

6. An easily-maintainable lamp connection device of claim 2, characterized in that said hinge mechanism includes an axle and a fixed plate fixed firmly at the inside wall of the front head by using screws, the connecting end of the fixed plate wraps around the axle and forms hinge structure; said lower end of moveable link rod wraps around the axle and forms hinge structure.

7. An easily-maintainable lamp connection device of claim 3, characterized in that said hinge mechanism includes an axle and a fixed plate fixed firmly at the inside wall of the front head by using screws, the connecting end of the fixed plate wraps around the axle and forms hinge structure; said lower end of moveable link rod wraps around the axle and forms hinge structure.

8. An easily-maintainable lamp connection device of claim 6, characterized in that the both ends of said axle are fixed at the inside of assembling recess located on the wall of the front head.

9. An easily-maintainable lamp connection device of claim 7, characterized in that the both ends of said axle are fixed at the inside of assembling recess located on the wall of the front head.
